(19) United States
(12) Patent Application Publication
(10) Pub. No.: US 2007/0118388 A1
(43) Pub. Date: May 24, 2007

(54) System and method for providing data to a wireless device

(76) Inventors: Alistair Hamilton, Stony Brook, NY (US); Jorg Schlieffers, Streatley-on-Thames (GB)

Correspondence Address: FAY KAPLUN & MARCIN, LLP, 15O BROADWAY, SUITE 702, NEW YORK, NY, 10038, US

(21) Appl. No.: 11/286,070

(22) Filed: Nov. 23, 2005

(51) Int. Cl. G06Q 99/00

(52) U.S. Cl. 705/1

(57) ABSTRACT

Described is a system comprising a database, a wireless computing unit and a server. The database stores product data which includes a product identifier of a product, at least one function identifier corresponding to the product and product-function data for each of the at least one function of the product. The unit obtains the product identifier and one of the at least one function identifier and generates a data request as a function of the product and one of the least one function identifiers. The server receives the data request and obtains corresponding product-function data from the database as a function of the data request. The server generating a response message as a function of the corresponding product-function data for wireless transmission to the unit.

### BACKGROUND

In a retail environment, a consumer is typically provided with limited information regarding a product. For example, product information may be included on a package or in a product display. The package usually details nutritional information, and the product display may include a discount or coupon. However, there is other information regarding the product that may be useful to the consumer when making a purchasing decision which is not provided by the manufacturer of the product or a store operator. Thus, the customer must seek out a store employee who, even when asked, may not provide the sought after information.

### SUMMARY OF THE INVENTION

The present invention relates to a system comprising a database, a wireless computing unit and a server. The database stores product data which includes a product identifier of a product, at least one function identifier corresponding to the product and product-function data for each of the at least one function of the product. The unit obtains the product identifier and one of the at least one function identifier and generates a data request as a function of the product and one of the least one function identifiers. The server receives the data request and obtains corresponding product-function data from the database as a function of the data request. The server generating a response message as a function of the corresponding product-function data for wireless transmission to the unit.

### BRIEF DESCRIPTION OF THE DRAWINGS

FIG. 1 shows an exemplary embodiment of a system according to the present invention;

FIG. 2a shows an exemplary embodiment of a function catalog arrangement according to the present invention;

FIG. 2b shows another exemplary embodiment of the function catalog arrangement according to the present invention;

FIG. 3 shows an exemplary embodiment of a method according to the present invention; and

FIG. 4 shows an exemplary embodiment of product data stored in a database according to the present invention.

### DETAILED DESCRIPTION

The present invention may be further understood with reference to the following description and the appended drawings, wherein like elements are referred to with the same reference numerals. The present invention generally relates to a system and method for providing data to a wireless device. In a retail environment, the data may be provided to the device as a result of a data request regarding a particular item. The data request and the corresponding item may be stored for a later purpose, e.g., marketing analysis. Although, the present invention will be described with respect to implementation in the retail environment, those of skill in the art will understand that the system 5 may be utilized in any location (e.g., a library, a warehouse, etc.) which utilizes a wireless communications network to serve data requests from remote locations.

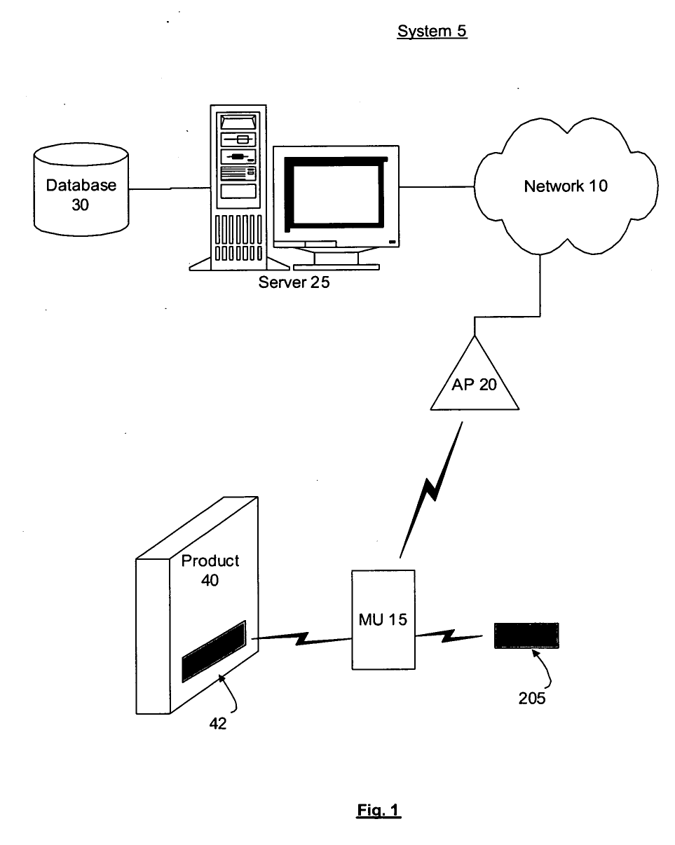

FIG. 1 shows an exemplary embodiment of a system 5 according to the present invention. The system 5 may include a communications network 10 (e.g., a wired/wireless LAN) which is accessible by a portable electronic device (e.g., a mobile unit (“MU”) 15) via an access point/port (“AP”) 20. The MU 15 may be any portable electronic device including, but not limited to, a laser/image-based scanner, an RFID reader/tag, a cell phone, a PDA and a tablet. Preferably, the MU 15 includes a barcode scanner and a display (e.g., LCD). The network 10 may include one or more network computing devices (e.g., switch, router, hub, etc.) which are managed by a server 25. The server 25 may include and/or be coupled to a database 30 which stores product data and data regarding operation of the system 5 and the components thereof, as will be described below.

When browsing products in a retail store, a user may utilize the MU 15 to obtain a product identifier (e.g., product data) corresponding to a particular product. For example, the MU 15 may scan a barcode 42 on a product 40 to generate barcode data. The barcode data is transmitted over the network 10 to the server 25 which identifies the product data as a function of the barcode data. The server 25 returns the product data to the MU 15 which shows the product data on its display. The product data may include, for example, a price, inventory, discount, etc. related to the corresponding product.

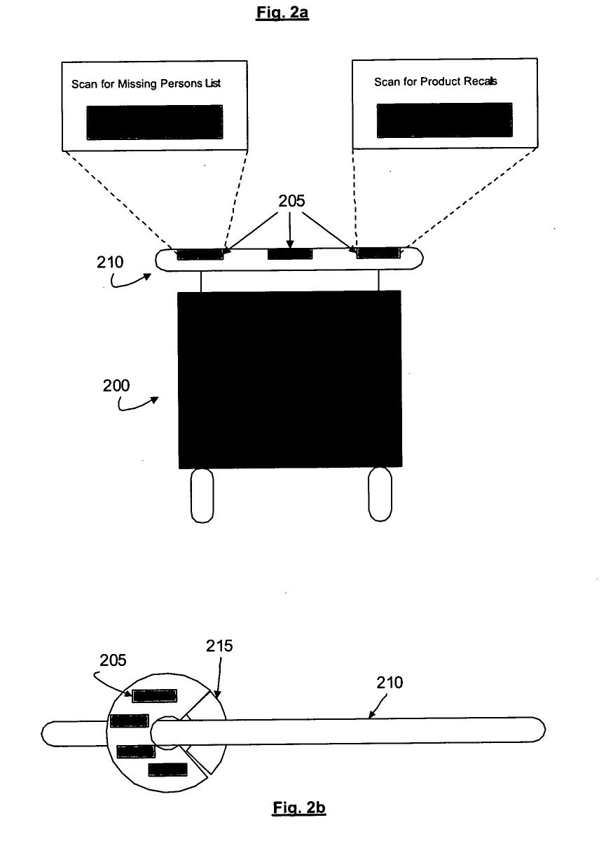

According to the present invention, the retail store may position function barcodes at various locations throughout the store which, when scanned, gather data from the database 30. For example, as shown in FIG. 2a, a shopping cart 200 may include a function catalog arrangement including one or more function identifiers (e.g., function barcodes 205) positioned on a handle 210 thereof. The function barcodes 205 may be different from product barcodes in that the function barcodes 205 correspond to a predetermined function, not a specific product. For example, one of the function barcodes 205 may be labeled “Missing Persons” indicating that a scan thereof returns a list of missing persons stored in the database 30. The list of missing persons which may be displayed on the display of the MU 15 may include, for example, an image of the person, a date reported missing, a location last seen, etc. The MU 15 allows the user to toggle through the results to view the entirety of the list. In an exemplary embodiment, the MU 15 may provide an input arrangement (e.g., keypad, phone, walkie-talkie, etc.) allowing the user to provide feedback based on a listing.

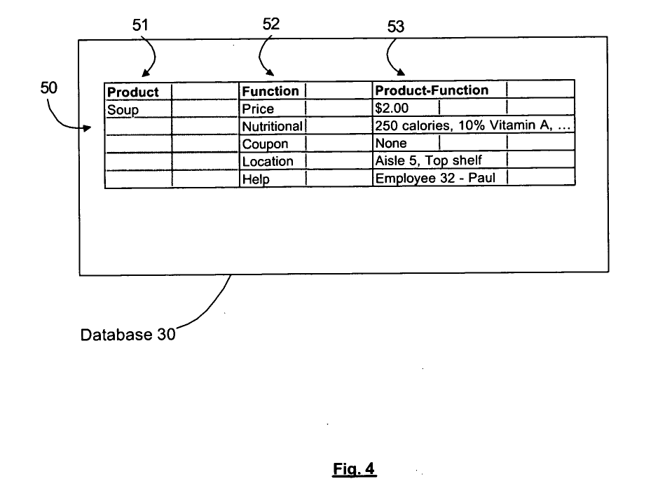

Another exemplary function barcode which may be included on the handle 210 may be labeled “Product Recalls”. This may be one of a plurality of function barcodes. For example, the function barcodes may further include, but are not limited to, “Product Information”, “Nutritional Information”, “Compare”, “Coupons”, “Rebates”, “Discounts”, “Purchase”, “Help” and “Location”. Each of the function barcodes, when combined with a scan of one or more product barcodes, initiates a corresponding predetermined action. For example, the user may have scanned a barcode on a container of milk. The user may then scan the Product Recalls barcode on the handle 210. The MU 15 combines the data from the product barcode with data from the Product Recalls barcode to generate a data request which is transmitted to the server 25 over the network 10. The server 25 queries the database 30 using the data request to obtain product-function data, shown in FIG. 4, for generating a response message. In this example, the response message may include data (e.g., a text message) indicating that there have been no recalls for this product. The response message may further include an option to purchase the product, which, if accepted, may instruct the user to scan the Purchase barcode on the handle 210.

When combined with a scan of a product barcode, the Product Information and/or Nutritional Information barcodes may return data indicative of, for example, the price, inventory, dietary information, etc. The Coupons, Rebates and Discounts barcodes may provide information on price reductions regarding the corresponding product. The Help barcode, when scanned, may initiate a response from store personnel who are assigned to assist customers with the corresponding product. The Location barcode may be utilized to return a location of the product in the retail store. In this manner, the customer may scan the product barcode in a circular, and the location of the product in the retail store may be displayed on the MU 15.

The Compare barcode may be combined with, for example, scans of two or more product barcodes and one of the remaining product-related barcodes. For example, the MU 15 may scan a first product (e.g., X-brand cereal) and then scan the Compare barcode which prompts the user to scan a second product (e.g., Y-brand cereal). The MU 15 may then scan, for example, the Product Information barcode to return a side-by-side comparison of the Product Information of the first and second products.

In the exemplary embodiment shown in FIG. 2a, the function catalog arrangement is shown as a plurality of function barcodes 205 positioned on the handle 210 of the shopping cart 200. In this embodiment, the handle 210 may include an interchangeable portion where one or more function barcodes 205 may be replaced. Alternatively, the function barcodes 205 may be stickers and simply adhered over older barcodes.

FIG. 2b shows another exemplary embodiment of the function catalog arrangement which includes a disc 215 rotatably coupled to the handle 210 of the shopping cart 200. The function barcodes 205 may be arranged on an exterior face of the disc 215, so that the function barcodes 205 are accessible by spinning the disc 215 on the handle 210. Those of skill in the art will understand that any number of discs may be coupled to the handle 210. Furthermore, the function catalog arrangement may be coupleable to any equipment that the retail store may provide to the customer. That is, the arrangement may be coupleable to a hand-carried basket, a stroller, etc. In other exemplary embodiments, the arrangement may simply be a list of the function barcodes 205 on a clipboard or a roll-a-dex arrangement.

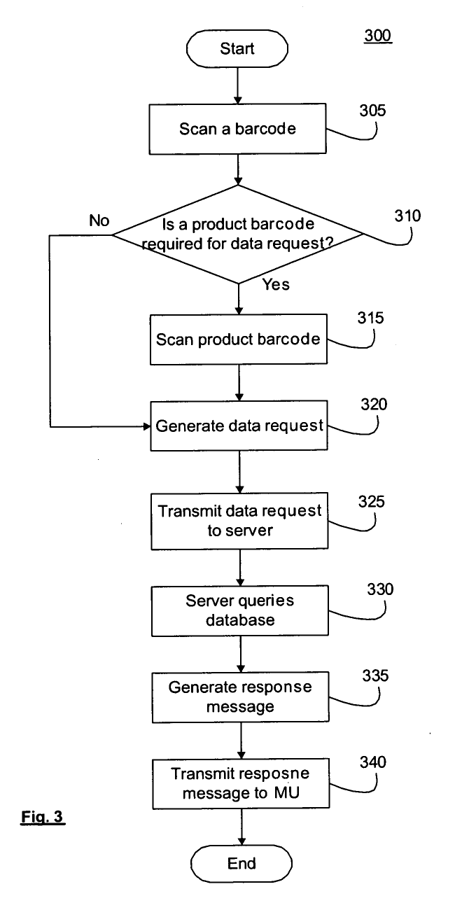

FIG. 3 shows an exemplary embodiment of a method 300 for providing data to a wireless device according to the present invention. In step 305, the MU 15 scans a barcode. In step 310, it is determined whether the barcode is a function barcode which would require a product barcode to generate a data request. For example, when the barcode scanned in step 305 is the Missing Persons barcode on the function catalog arrangement, the user is requesting an updated list of missing persons. This function barcode may not require association with a particular product to retrieve the list from the database 30, and the method may proceed to step 320.

In step 315, the MU 15 scans a product barcode (e.g., barcode 42), because, for example, the barcode scanned in step 305 may have been a function barcode such as, Nutritional Information. Those of skill in the art will understand that the steps 305 and 315 may be reversed, in that the scan of the product barcode may occur prior to the scan of the function barcode. As described above, the step 315 may include scanning one or more function barcodes prior to generating the data request. For example, the Compare barcode may require at least two product barcodes and at least one function barcode (e.g., Nutritional Information).

In step 320, the MU 15 generates the data request including barcode data from one or more barcode scans (e.g., product barcode(s) and/or function barcode(s)). In step 325, the data request is transmitted to the server 25 over the network 10. That is, the MU 15 and the AP 20 may utilize a predetermined wireless communications protocol (e.g., IEEE 802.1x protocol) for conducting wireless communications. The data request may be forwarded by the AP 20 to the server 25 via the network 10. Those of skill in the art will understand that in another exemplary embodiment of the present invention, the AP 20 may be directly connected to the server 25.

In step 330, the server 25 queries the database 30 as a function of the data request. As described above, the database 30 may store product data 50 as shown in FIG. 4. The product data 50 may include a product identifier 51, at least one function identifier 52 corresponding to the product identifier 51 and product-function data for each of the function identifiers. In step 335, the server 25 obtains the relevant data (e.g., the product-function data) from the database 30 and generates a response message. For example, when the data request includes the product barcode for “Soup” and the function barcode Coupon, the corresponding product-function data is “None”. In step 340, the response message is transmitted to the MU 15. When the response message is received, the product-function may be shown on the display of the MU 15.

Although, the present invention has been described with reference to providing data to the MU 15 as a function of the data request, the present invention may be utilized to gather marketing data regarding customer purchasing patterns. For example, along with fulfilling the data request, the server 25 may store the data request and corresponding customer data which may then be analyzed to determine customer purchasing patterns.

In this exemplary embodiment, the customer may enter customer data into the MU 15 prior to scanning. For example, the customer data may include a credit card number, a unique identifier, demographic data (e.g., name, address, income, children, marital status, etc.), etc. The MU 15 may transmit the customer data to the server 25 which may generate a customer record. The user may then begin to utilize the MU 15 as described above. When the server 25 receives a data request, the server 25 may fulfill the data request and store the data request in the customer record.

After the customer has finished making purchases, the customer record may be analyzed. For example, if the Help barcode was scanned more than a predetermined number of times, a network operator or store proprietor may determine that the system 5 is not user-friendly enough. Thus, a new interface may be developed for the MU 15 and/or system instructions may be provided throughout the retail store. In another example, if the Missing Persons barcode was scanned more than a predetermined number of times or by more than one customer during a predetermined time period, the network operator may reconfigure the system 5 to have the server 25 download the missing persons list to each of the MUs in the retail store at predetermined intervals.

The customer records may further be utilized for marketing analysis. For example, the data requests which include a scan of the Compare barcode indicate that the customer may be choosing between two or more products. This information may be valuable to product manufacturers and marketing companies for assessing competitor products and analyzing marketing strategies. Additionally, the store proprietor may utilize the information for product placement within the retail store. Because product placement typically comes at a premium (e.g., higher price for eye-level placement), the store proprietor may place competing products directly next to each other to foster competition.

Those of skill in the art will understand that the customer record may be utilized in various ways. For example, targeted advertising may be downloaded to the MU 15 based on the customer data. That is, after the customer has purchased a particular item, on subsequent trips to the retail store, the server 25, upon receipt of the customer data, may download coupons and/or rebates to the MU 15 regarding the particular item.

Those of skill in the art will understand that the “Missing Persons” barcode is an example of a function barcode which may not require combination with a product barcode. Other function barcodes which may not require combination with the product barcode include, but are not limited to, “Help” and “Location”. The Help barcode, when scanned, may return a list of instructions on how to use the MU 15. Scanning the Help barcode may also send a request for assistance to store personnel. The location of the MU 15 within the store may be determined using any wireless communications locationing technique (e.g., signal strength triangulation, TDOA, etc.) and the store personnel may be directed to the location of the MU 15. Also using this technique, the MU 15 may identify its location within the store and show the location on an image/map of the store on the display when the Location barcode is scanned.

Additionally, the present invention allows the user to access multiple sources of information in a “one-click” manner. For example, the missing persons list is available to the user upon a single scan of the Missing Persons barcode located on the shopping cart 200. Similarly, the product information is available to the user upon a scan of the product barcode and a scan of the Product Information barcode. Thus, the present invention provides the precise information requested by the user.

It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

What is claimed is:

1. A system, comprising:
a database storing product data, the product data including a product identifier of a product, at least one function identifier corresponding to the product and product-function data for each of the at least one function of the product;
a wireless computing unit obtaining the product identifier and one of the at least one function identifier, the unit generating a data request as a function of the product and one of the least one function identifiers; and
a server receiving the data request, the server obtaining corresponding product-function data from the database as a function of the data request, the server generating a response message as a function of the corresponding product-function data for wireless transmission to the unit.

2. The system according to claim 1, wherein the unit includes a barcode scanner, the scanner scanning a first barcode to obtain the product identifier and a second barcode to obtain one of the at least one function identifier, the unit generating the data request as a function of the first and second barcodes.

3. The system according to claim 1, wherein the unit includes a display displaying the corresponding product-function data.

4. The system according to claim 1, wherein the unit includes at least one of a phone, a PDA, an image-based scanner, a laser-based scanner and an RFID reader.

5. The system according to claim 1, wherein the at least one function identifier is disposed on one of a shopping cart, a shopping basket, a clipboard, a rotatable disc coupled to a shopping cart handle, a shelf, an in-store display and a wall.

6. The system according to claim 1, wherein the at least one function identifier includes at least one of Missing Persons, Product Recalls, Product Information, Nutritional Information, Product Comparison, Coupon, Rebate, Discount, Purchase, Help and Location.

7. The system according to claim 1, wherein the data request further includes customer identifier data, the server compiling a customer record as a function of the customer identifier data, the data request and the response message.

8. A method, comprising:
obtaining, by a wireless computing unit, a product identifier and at least one function identifier;
generating a data request by the unit as a function of the product identifier and the at least one function identifier;
transmitting the data request to a server;
querying a database as a function of the data request, the database storing product data, the product data including a product identifier of a product, at least one function identifier corresponding to the product and product-function data for each of the at least one function of the product;
obtaining, by the server, corresponding product-function data from the database as a function of the data request; and
generating, by the server, a response message as a function of the corresponding product-function data for wireless transmission to the unit.

9. The method according to claim 8, wherein the generating the data request step further includes the following substeps:
scanning, by the unit, a first barcode corresponding to the product identifier and a second barcode corresponding to one of the at least one function identifier; and
generating the data request as a function of the first and second barcodes.

10. The method according to claim 8, further comprising:
displaying the corresponding product-function data by the unit.

11. The method according to claim 8, wherein the unit includes at least one of a phone, a PDA, an image-based scanner, a laser-based scanner and an RFID reader.

12. The method according to claim 8, wherein the at least one function identifier is disposed on one of a shopping cart, a shopping basket, a clipboard, a rotatable disc coupled to a shopping cart handle, a shelf, an in-store display and a wall.

13. The method according to claim 8, wherein the at least one function identifier includes at least one of Missing Persons, Product Recalls, Product Information, Nutritional Information, Product Comparison, Coupon, Rebate, Discount, Purchase, Help and Location.

14. The method according to claim 8, wherein the data request further includes customer identifier data corresponding to a user of the unit.

15. The method according to claim 14, further comprising:
compiling, by the server, a customer record as a function of the customer identifier data, the data request and the response message.

16. An arrangement, comprising:
a scanner obtaining a product identifier and at least one function identifier;
a processor generating a data request as a function of the product identifier and the at least one function identifier; and
a communication arrangement transmitting the data request to a server, the server querying a database as a function of the data request, the database storing product data, the product data including a product identifier of a product, at least one function identifier corresponding to the product and product-function data for each of the at least one function of the product, the server obtaining corresponding product-function data from the database as a function of the data request, the server generating a response message as a function of the corresponding product-function data and transmitting the response message to the communications arrangement.

17. The arrangement according to claim 16, further comprising:
a display displaying the corresponding product-function data.

18. The arrangement according to claim 16, wherein the arrangement is one of a phone, a PDA, an image-based scanner, a laser-based scanner and an RFID reader.

19. The method according to claim 16, wherein the memory stores customer identifier data, the processor including the customer identifier data in the data request.

20. The method according to claim 19, wherein the customer identifier data includes at least one of a name, an address, an age and a credit card number.
